(19) United States
(12) Patent Application Publication
(10) Pub. No.: US 2010/0263306 A1
(43) Pub. Date: Oct. 21, 2010

(54) ROOM WITH TWO COUNTER-RESISTANT INSECTICIDAL OBJECTS

(76) Inventor: Mikkel Vestergaard Frandsen, Lausanne (CH)

Correspondence Address: JAMES C. WRAY, 1493 CHAIN BRIDGE ROAD, SUITE 300, MCLEAN, VA, 22101, US

(21) Appl. No.: 12/734,493

(22) PCT Filed: Nov. 3, 2008
(86) PCT No.: PCT/DK2008/050267

§ 371 Date: May 5, 2010

(30) Foreign Application Priority Data
Nov. 5, 2007 (DK) PCT/DK2007/000480

(51) Int. Cl. A01N 25/34; A01P 7/04

(52) U.S. Cl. 52/173.1; 424/402

(57) ABSTRACT

A room for humans or animals, the room comprising a first object and a second object remote from the first object, the first object comprising a first releasable insecticide against a target insect, the first insecticide having a certain probability for inducing resistance against the insecticide among the target insects, the second object comprising a second releasable insecticide, the second insecticide being configured for insecticidal efficiency against the target insect despite resistance against the first insecticide.

### FIELD OF THE INVENTION

The present invention relates to insecticidal objects for counteracting insecticidal resistance.

### BACKGROUND OF THE INVENTION

A number of different insects cause substantial problems as vectors and transmitters of infectious diseases affecting humans, and tremendous efforts have been invested in controlling these insects. Efforts have been concentrated on controlling insects belonging to the order Diptera (covering mosquitoes, gnats, black flies, tsetse flies and other biting flies), Hemiptera (covering bed bugs) and Siphonaptera (covering fleas). Methods to control these insects include treating inner and outer surfaces of walls, air spraying, as well as impregnation of curtains and bed nets. The impregnation of curtains and bed nets has the advantage that the surface area to be treated is much reduced compared to a surface spraying of a house. The impregnation of the bed net reduces nuisance during sleeping and has been shown to be effective even if the net is slightly torn due to use.

The effect of a netting or fabric impregnated with a Pyrethroid is partly based on the fast insecticidal property of these insecticides, but also on the repellent effect inherent in some of these insecticides. Tests have shown that an impregnated bed net reduces the number of mosquitoes entering the room with up till 75%. Thereby, the net also provides some protection for other persons sleeping in the same room even though they are not covered by the net.

In some areas, however, mosquitoes are resistant to Pyrethroids. One of these resistance types, so-called knock down resistance or KDR, also provides resistance to the repellent effect. This allows the mosquitoes to rest for a longer time on the net and thus to accumulate a lethal dosage of the insecticide, but it also gives the mosquitoes the possibility to bite before dying. Another form for resistance is metabolic resistance, where the insect has enzymes counteracting the insecticidal effect.

In this case, a synergist, for example piperonyl butoxide (PBO), can be added to the net with great advantage. Using synergists in coatings in connection with bed nets or fabrics is disclosed in Chinese patent application CN1099825 by Ye Qian, in International patent application WO 90/14006 by Mooney et al., WO06128870 by Karl et al, and WO06128867 by Koradin et al, in Japanese patent applications JP 02-062804, JP 04-185766, JP 06-346373, and JP 07-316003 by Fujita et al., U.S. Pat. No. 5,503,918 by Samson, and US patent application No. US20070009563A1 by Hataipitisuk. Incorporating a synergist in a polymer matrix together with an insecticide is disclosed in US patent application No. US20060288955 by Albright et al. and in International patent application WO 00/40084 by Kellerby and Fletcher.

A proposal for fighting resistance is found in the article “Comparative evaluation of carbosulan- and permethrin-impregnated curtains for preventing house-entry by the malaria vector. Anopheles gambiae in Burkino Faso” by C. Fanello et al. and published in Medical and Veterinary Entomology (2003) 17, 333-338. The article discloses use of carbamate treated curtains instead of pyrethroid treated curtains. Such carbamate curtains are proposed to hang in doorways when people are sleeping under non-treated mosquito nets. However, this implies a great disadvantage, because people get in contact with the hazardous carbamate when they walk through the doorways.

Another proposal to fight insecticidal resistance is disclosed in International patent application WO/2007 085640 by Skovmand, where one part of an insecticidal fabric, for example netting, is impregnated with one insecticide and another part is impregnated with another insecticide, wherein at least one of the insecticides exhibits killing of insects on distance.

Despite the apparent advantage at first sight, this system has a severe disadvantage when studying this in the light of the behaviour of insects, such as mosquitoes. As the distant killing effect of the first insecticide also has a repellent effect on those mosquitoes that have metabolic resistance—in contrast to KDR resistance—these resistant mosquitoes will not land on the net and get in contact with the second insecticide. Thus, no killing of metabolic resistant insects will be achieved. Also, due to the lethal doses in the surrounding of the nets or fabrics, only a small number of insects will actually fly into the space with lethal action. Thus, if the insects are not confined within the space, where the evaporation of the insecticide is so high that it will kill the insects, the insects will stay outside this space and will not be killed. Though this system may be efficient to hold a space free from insects, this system is not at all good for killing insects. However, especially to fight malaria, it is important to kill the insects, because the insects would just find another place with another victim outside the range of the distant killing effect. Therefore, other systems for fighting malaria are necessary.

It is also mentioned in International patent application WO/2007 085640 by Skovmand that a fabric that exhibits distant killing can be hanging in the same room as a bednet for increasing the effect of the bednet. Also this system is not suited for fighting malaria, where the mosquitoes are actually killed. In this case, the fabric would have an insecticide that exhibits distant killing whereas the bednet may have or may not have an insecticide which exhibits killing on distance. However, as the distant killing effect would work as a repellent, such a system would only prevent mosquitoes to enter a room but not add to the reduction of malaria bearing mosquitoes.

The article “Combined pyrethroid and carbamate ‘two-in-on’ treated mosquito nets: field efficiency against pyrethroid-resistant Anopheles gambiae and Culex quinquefaciatus” by P. Guillet et al, published in Medical and Veterinary Entomology (2001) 15, 105-112, discloses an experiment, where mosquito nets were evaluated with the upper part treated with the carbamate carbosulfan and the lower part was treated with the pyrethroid bifenthrin or deltamethrin. These two-in-one treated nets, where carbamates were combined with pyrethroids, were experimentally not found as good in mosquito killing than nets with only carbamates, but better than nets only with the pyrethroids. Also reported in this article is the fact that mosquitoes always try to attack from above the net and always would land on the carbamate treated part of the net first. In this light and having in mind the high killing efficiency of the carbamate reported in this article, it seems not at all necessary to have a lower part of the net treated with a pyrethroid. The conclusion of necessity or advantage of having a two-in-one net cannot be shared with the authors of this article. Especially when it comes to the aim of actually killing of the mosquitos, it seems on the basis of this article that carbamate treated nets are much better than pyrethoid treated nets due to the lack of repellent action of the carbamates.

However, carbamates are generally more hazardous for humans than pyrethroids, such as Deltamethrin, which is use in the commercially available PermaNet™, or Permethrin, which is used in the commercially available Olyset Net®. This is why mosquito nets with those pyrethroids are still the dominant nets on the market. Because carbamate nets are not yet an optimal solution, different systems have to be found for efficient malaria reduction.

In the light of the above arguments in connection with insecticidal resistance, there is an ongoing effort for finding formulations, product forms and methods for reducing the nuisance of insects, especially mosquitoes and flies, and the diseases caused by them, which includes measures against insecticidal resistance of different types, and there is an urgent need to adopt new strategies to prevent the spread of insecticide resistance and especially malaria.

### OBJECT OF THE INVENTION

It is therefore the object of the invention to provide a new system for fighting insecticidal resistance of insects, primarily mosquitoes.

### DESCRIPTION OF THE INVENTION

This object is achieved by a room for humans or animals, the room comprising a first object and a second object remote from the first object. The first object comprises a first releasable insecticide, for example a pyrethroid, configured for contact killing of a target insect, primarily mosquitoes. The first insecticide has a certain probability for inducing resistance of the target insect against the first insecticide. The second object comprises a second releasable insecticide different from the first insecticide, for example a Carbamate, the second insecticide being configured configured for contact killing and for insecticidal efficiency against the target insect despite resistance of the target insect against the first insecticide.

By providing different objects in the same room with different insecticides, insects resistant to one of the insecticides can be targeted efficiently. The term “remote” is to be understood in the way that the two objects are separated objects with a distance in between, for example such that the first object is located in one part of the room and the other object is located in another part of the room. The term insecticide also covers entomopathogens.

The term contact killing means a killing effect that is achieved by the insect contacting the object. In contrast thereto, in the case of distant killing, either the insect is repelled before any contact with the object, or the insect is killed before contact; thus, typically, no contact is established. The fact that minute amounts of the insecticide may be released air born as dust or as vapour is not relevant in this context, if there is not achieved a killing effect of the insects. Actually, the contact killing in contrast to the distant killing has a much smaller repellent effect, such that more mosquitoes are killed.

In this context, it should be emphasized that a killing effect always is statistical, it may be less than 100% and still count as a killing effect if it is in line with typically used criteria and protocols in this field. Thus, the contact killing in connection with the invention assumes that more than 50%, for example more than 75% or more than 90%, or even more than 95% or 99% of the mosquitoes landing on the object are killed by contact—unless the insect is resistant. According to the invention, the predominant number of insects that are killed, are killed by contact killing. No substantial number of insects are killed by distant killing. For example less than 25%, rather less than 10% or less than 5%, or most preferably—and most realistic in connection with Deltamethrin coatings—less than 1% of the mosquitoes in the room are killed by distant killing.

Actually, Deltamethrin is regarded as an insecticide that does not kill on distance. This is also supported by the fact that in the International patent application WO/2007 085640 by Skovmand, the stated Example 2 shows that only a net treated with alphacypermethrin had an indication of distant killing, whereas the Deltamethrin treated net did not show a distant killing effect. The fact that Example 1 of the Skovmand application shows distant killing effect by a Deltamethrin treated net is believed to be due to release of Deltamethrin dust, which is not part of the net impregnation itself but part of remnants of Deltamethrin dust from the production. After washing, this dust is removed as in Example 2 of the Skovmand application, and, advantageously, there is no distant killing effect.

In the following the invention will be illustrated by the example of a bed net against mosquitos and a wall lining, though other combinations are possible, as it also appears from below.

As described in the article by Guillet et al. as mentioned above, mosquitoes tend to approach humans lying in a bed from above. Thus, the mosquito will land on the bed net, typically on the roof part, especially if the net is a rectangular net, and the mosquito will work its way down along the side walls of the bed net in order to find a passage to the potential victim underneath the bed net. During its way down, the insect is exposed to the first insecticide, for example a Pyrethroid, which will lead to a death of the insect, unless the insect is resistant against the Pyrethroid. If the insect is resistant, the insect will find a place to rest, waiting for a chance to attack a potential offer. Typically, the mosquito will find a place on a wall. Also, in the case where a mosquito has taken a blood meal, it will rest indoor for digestion and maturing its eggs. Using this knowledge, it is an advantage if the wall is covered with the second object in the form of a wall lining. This wall lining is provided with a second insecticide, for example a Carbamate, because insects tend not to be resistant against Pyrethroids and Carbamates at the same time. As the Carbamate is not harmless to the human, as is the commonly used Pyrethroid Deltamethrin, there is an advantage of using Deltamethrin for the bed net and a Carbamate, for example Bendiocarb, for the wall.

There are numerous advantages of a system with separate objects in the room as compared to a net that is treated with a carbamate on the upper part and a pyrethroid on the lower part, such as reported in the article by Guillet et al mentioned above. In order to illustrate the advantages, the “two-in-one” net reported by Guillet et al is compared to an embodiment of the invention, where a Deltamethrin treated mosquito net is combined with a carbamate treated wall lining. A first advantage is seen when having regard to the fact that mosquito nets are washed regularly. Whereas a net containing carbamates would expose the washing person to the hazardous insecticide, a mosquito net with Deltamethrin is basically harmless. A second advantage is due to the fact that a wall lining typically is not washed. This prevents the washing person from being exposed to carbamates and, more important, the carbamate content is not reduced due to the washing. This implies that the carbamate content may be less than in a long lasting “two-in-one” net, and it would also have a controlled longer period of insecticidal action. A third advantage is the fact that the repellent action of pyrethroids affects the remote carbamate-treated wall lining much less than the carbamate-treated top of the “two-in-one” net. A fourth advantage is the fact that those mosquitoes that have actually fed in the room would rest on the wall covered with the wall lining and be killed, whereas mosquitoes would not rest on the mosquito net, which is not in a dark place and not in a quiet location of the room. A fifth advantage is seen when having regard to the fact that actual users of mosquito nets prefer white nets and dark wall coverings. A dark wall lining attracts mosquitoes for resting, whereas a white top of a “two-in-one” mosquito net does not, which implies a higher probability of killing resistant mosquitoes by the wall lining than by a two-in-one net. A sixth advantage is the fact that carbamate treated nets are not recommended by WHO for use in bed-nets.

Even though the invention may seem simple, the full effect of it is only understood with thorough knowledge of the behaviour of mosquitoes.

Carbamates inhibit different metabolic enzymes, thereby slowing down the development of resistance to Pyrethroids. Bendiocarb is a Carbamate and acts as an inhibitor to acetylcholine esterase enzymes; Bendiocarb, therefore, uses a different mode of action to Pyrethroids and can also be synergized with PBO. Carbamate resistance is not as widespread as Pyrethroid resistance in Africa and a combination according to the invention with these insecticides is expected to reduce the spread of the Knock Down Resistance gene and prolong the effective life of Deltamethrin.

Additionally, it has been recognised that mosquitoes tend to rest on high positions on the wall. Thus, it suffices in most cases, if the high part of the wall is provided with a lining that comprises the second insecticide. Advantageously the insecticidal wall lining—or at least the insecticidal part of the wall lining—is only provided above a certain height, for example higher than 1 meter, rather above 1.2 m and preferably above 1.6 m, because this also reduces the contact with humans, especially children. The reduction of the contact is important in the case that the insecticide is harmful to humans, which may be the case for Carbamates. If an elevated wall lining or the upper part of the wall lining is provided with a Carbamate, this prevents the risk for children touching the net and being exposed to the Carbamate. However, the wall lining may comprise a further insecticide, for example Deltamethrin on the lower part, as Deltamethrin is not regarded as harmful to humans.

Furthermore, for resting, the mosquito prefers parts of the wall that are in a dark colour. Thus, providing a wall lining with a top part comprising a releasable insecticide, where the top part has a dark colour has an efficient effect on the killing of mosquitoes.

This system can be made even more efficient by providing a synergist, for example PBO, on the roof part of the mosquito net, which is typically the first object of approach by the mosquito and which results in an early uptake of the synergist by the mosquito.

Another important feature should be recognised. In many African countries, dwellings comprises huts with walls and a roof and a space between the upper edge of the walls and the roof, typically a space with a height of 0.2 m to 0.4 m. Mosquitoes and other insects tend to enter the but through these spaces, why the user of the dwellings typically try to cover these spaces with materials like curtains or foils. As an improvement against insecticides, the huts have been sprayed with insecticide in some instances as a countermeasure. However, the insecticidal effect lasts only a couple of months, until the treatment has to be repeated. By covering such spaces with an insecticidal wall lining in the form of a fabric, for example a shade net, a foil or a tarpaulin, a several years' long lasting effect against insects can achieved by, on the one hand, functioning as a barrier against insects, and, on the other hand, exposing the insects to an insecticide. The term fabric also covers Dumuria fabrics, being special texturised woven fabrics. Commercially, these are available under the trademark PermaNet® Dumuria.

In this case, where the first object is a bed net with a roof part and side walls, and wherein the roof part comprises a synergist, this synergist may advantageously by migratably incorporated in the material of the roof part of the bed net, either without insecticide or with insecticide. If the synergist is provided by incorporation into the material of the top part, the insecticide may be incorporated as well or provided by a surface treatment, such as impregnation. Alternatively, the synergist may be provided by surface treatment, and the insecticide may be incorporated in the material of the roof part. In the case of incorporation of insecticide and/or synergist into the material, the material is advantageously polyethylene due to its low melting point, which makes it highly suitable for fibre extrusion without disintegrating the synergist and insecticide. However, because of its popularity due to the cotton-like feeling, the side walls of the bed net are preferably multifilament, for example multifilaments made of polyester polyethylene or polypropylene. As polyester has a higher melting point than polyethylene, the insecticide may advantageously be provided by surface treatment, for example by impregnation.

However, the example of the first object being a bed net is for illustration only, and other objects can be envisaged, for example other types of fabrics, foils or tarpaulins as part of the room.

Wall linings as described above may be used in other combination than with bed nets. For example, both the first and the second objects may be wall linings, where the first wall lining comprises a first insecticide, and the second wall linings comprises a secand insecticide. As already described in the exemplary combination with a bed net, such a wall lining may have a top part and a bottom part, where only the top part contains a releasable insecticide, or the insecticidal wall lining may only be provided above a certain height, in order to prevent humans, especially children to get into contact with the insecticide. Therefore, as describe above, it is preferred, if the wall lining or the top part of the wall lining is provided at a height of more than 1.6 m. In addition, the dark colour preferred by mosquitoes may be used for this top lining.

Alternatively, the second object is a curtain. In analogy with the wall lining example, such a curtain may advantageously have a top part and a bottom part, where only the top part contains a releasable insecticide. For example, the top part of the curtain is provided at a height of more than 1.6 m. Alternatively, the top part may be provided with one insecticide and the bottom part with another insecticide, where the insecticide of the lower part may be selected among those insecticides, which are not harmful to humans.

Another alternative for the first object or the second object or both are furnitures covered at least partly with insecticidal material.

It is of high interest that the insecticidal efficiency is long lasting. This can be achieved by impregnation of fabrics, for example as disclosed in International patent application WO 01/37662 by Skovmand or as described in International patent application PCT/DK2007/000179 both of which are herewith included by reference. Alternatively, a useful solution in connection with the invention is the case, where the first insecticide is migratably incorporated in at least part of the material of the first object. Other possibilities for the first and/or the second object among others include insecticidal barriers in the form of impregnated wood, paper, carpets, pesticidal blankets as described in WO03055307 or a tarpaulin as described in WO 03/063587.

In case that the first insecticide is a Pyrethroid, the second insecticide is advantageously a Pyrethroid-free insecticidal agent. If the first object—or the second object—comprises a synergist, the synergist may, advantageously, be chosen to be an efficiency enhancer for both insecticides. For example, PBO functions as a synergist for Deltamethrin as well as for Bendiocarb. Such a synergist may be migratably incorporated in at least part of the material of the first object or the second object or provided in a surface treatment as already mentioned in connection with the example of the bed net above. Other synergists include Sulfoxide, Tropital, Bucarpolate, ethion, profenofos, or dimethoate.

In analogy with the example with the bed net, but equally valid for other first objects, the first insecticide may be provided on a first part of first object and the synergist may be provided on second part of the first object but not on the first part. This reduces the costs of the first object, as not the entire object is treated with the relatively expensive synergist. As mosquitoes tend to attack from above, the second part of the first object is preferably above the first part of the first object.

Though the invention has been explained in the foregoing mainly as having a first insecticide on first object and a second insecticide on a second object, further insecticidal objects may be provided in a room, and the different object according to the invention may each comprise more than one insecticide, for example combinations of insecticides on the entire objects or different insecticides on different parts of the objects.

A more extensive list of possible insecticide is found in WO 01/37662 or in WO 06/128870 also containing examples of repellents. Further possible combinations include
a phenylsemicarbazone compound, preferably metaflumizone, as disclosed in international patent applications WO07/017518, WO07/017502 assigned to BASF and WO 06/127407 assigned to Wyeth,
an anthranilamid as disclosed in international patent application WO07/017433,
N-arylhydrazine as disclosed in international patent application WO06128870,
derivatives of 1-Phenyltriazole as disclosed in international patent application WO06128867, for example combined with a pyrethroid,
1-(Imidazolin-2-YL)Amino-1,2-Diphenylethane compounds as disclosed in international patent application WO06/125748,
1-(1,2-Diphenyl-ethyl)-3-(2-Hydroxyethyl)Thiurea compounds as disclosed in international patent application WO06/125745,
Malononitriles as disclosed in international patent application WO06/122949,
Biphenyl-N-(4-Pyridyl)Methylsufonamides as disclosed in international patent application WO06/097488 or WO06/097489,
Amidrazone compounds as disclosed in international patent application WO06/097279,
Hydrazide compound as disclosed in international patent application WO06/058730,
Azine compoundalso as disclosed in international patent application WO06/056462,
2-cyano-3-(halo)alkoxy-benzenesulfanomide as disclosed in international patent application WO06/056433,
Nanoparticulate organic pesticide compound as disclosed in international patent application WO06/002984,
N-arylhydrazine derivatives as disclosed in international patent applications WO05/053402 or WO05/053403,
5-(2-Arylacetanido)Isothiaziole compounds as disclosed in international patent applications WO05/040162 or WO05/040143,
Fluoralkene derivative as disclosed in international patent application WO04/013112.

Another alternative for a first object according to the invention is an insecticidal barrier, for example a bed net as described above, that has an upper insecticidal net part with a mesh size preventing selected insects, for example mosquitoes, to transverse the barrier and a lower part extending up to a height of more than 40 cm, for example 75 cm or 100 cm, from the lower edge of the barrier, the lower part comprising an insecticidal fabric, an insecticidal tarpaulin, an insecticidal foil, an insecticidal net with a net material having a higher tear strength than the net of the upper part, an insecticidal net with a net material having a higher mesh density or yarn density than the net of the upper part, or a combination of these. By providing an insecticidal barrier with a lower part made of fabric, tarpaulin, foil, or non-woven, the barrier has a higher strength of the lower part and a longer durability of the insecticidal effect than most mosquito nets according to prior art. These and further examples for objects in connection with the invention are described in International Patent application PCT/DK2007/000321 which hereby is incorporated by reference.

The term insecticidal fabric is to be understood on a general level and implies woven or knitted fabrics or non-woven.

A process for providing a non living insecticidal material, for example a fabric or netting, with a polymeric matrix into which at least one synergist is migratably incorporated before a coating with a coating containing at least one insecticide is described in International Patent application PCT/DK2007/000071 which hereby is incorporated by reference, as it advantageously is used in connection with the invention.

For a fabric in connection with the objects of the invention, insecticidal threads may be provided having a first and a second cross sectional part, the first part having an insecticide, an insect sterilising agent, an entomopathogen, or a synergist or a combination thereof incorporated in a polymeric material of the first part, the second part being free from insecticide, insect sterilising agent, entomopathogen, and synergist or the second part having an insecticide, an insect sterilising agent, entomopathogen, or synergist or a combination thereof incorporated in a polymeric material of the second part. The content of insecticide or synergist in the second part is different from the content of insecticide, insect sterilising agent, entomopathogen, or synergist or combination thereof of the first part. For example, the first part is a first type of filaments, whereas the second part is a second type of filaments. In this case, the insecticidal thread comprises a first type of filaments and a second type of filaments according to the invention. The first type of filaments has an insecticide, an insect sterilising agent, an entomopathogen, or a synergist or combination thereof incorporated in a polymeric material of the first type of filaments. The second type is insecticide-free, free of insect sterilising agent, free of entomopathogen, and synergist-free or has an insecticide, an insect sterilising agent, an entomopathogen, or synergist or a combination thereof incorporated in a polymeric material of the second type of filaments. The content of insecticide, insect sterilising agent, entomopathogen, or synergist or the combination thereof in the second type of filaments is different from the content of insecticide, insect sterilising agent, entomopathogen, or synergist or the combination thereof in the first type of filaments. This is described in more detail in International Patent application PCT/DK2007/000319 which hereby is incorporated by reference, as it advantageously is used in connection with the invention.

### DESCRIPTION OF THE DRAWING

The invention will be explained in more detail with reference to the drawing, where

FIG. 1 show a combination of a mosquito net and a wall lining, where a) the wall lining only covers a space between the wall and the roof, and b) the wall lining extends below the upper edge of the wall,

FIG. 2 shows a first embodiment of a bed net according to the invention with a roof that contains PBO,

FIG. 3 shows a second embodiment of a bed net according to the invention, the bed net having a skirt and a) a conical form and b) a rectangular form.

### DETAILED DESCRIPTION OF THE INVENTION

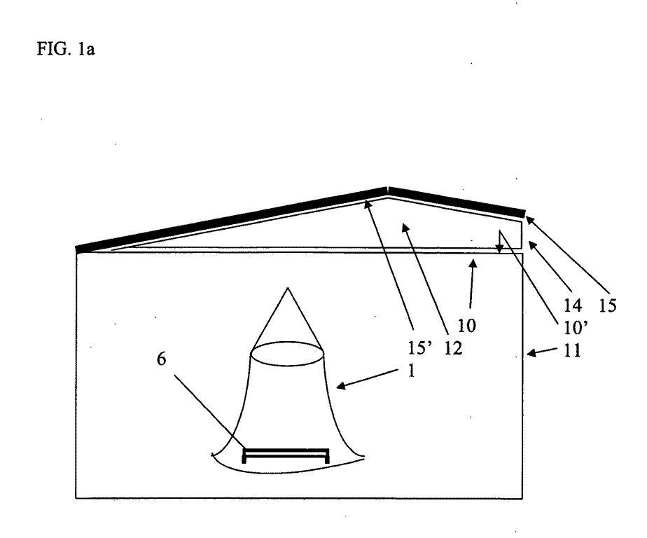

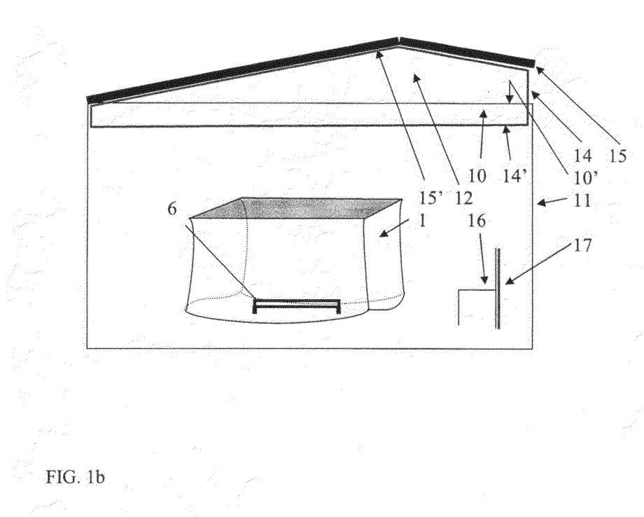

FIG. 1a illustrates a room 11 as part of a but will walls 10 and a roof 15. The roof 15 is located above the upper edge 10′ of the wall 10, thereby forming a space 14 between the upper edge 10′ of the wall 10 and the underside 15′ of the roof 15. The room 11 contains a bed net 1 over a bed 6 and a wall lining 12 filling the space 14 between the wall 10 and the roof 15. The wall lining 14 is shown as just covering the space 14, however, the lining 14 could as well extend below the edge 10′, as shown in FIG. 1b, and cover part or all of the wall 10. If the wall lining 14 comprises an insecticide harmful to humans, it is preferred that the lower edge 14′ of the wall lining 14 has a height such that risk for contact with humans is minimised. For example, the lower edge 14′ has a height of more than 1.6 meter. Alternatively, the wall lining may extend further down, possibly covering the entire wall 10; however, in this case, it is of advantage that an insecticide harmful to humans is only provided in an upper part of the wall lining 14.

Apart from the first object, which is a bed net, and the second object, which is the wall lining, the room may contain further insecticidal objects, for example furniture 16 that has an insecticidal covering 17 on part of the furniture.

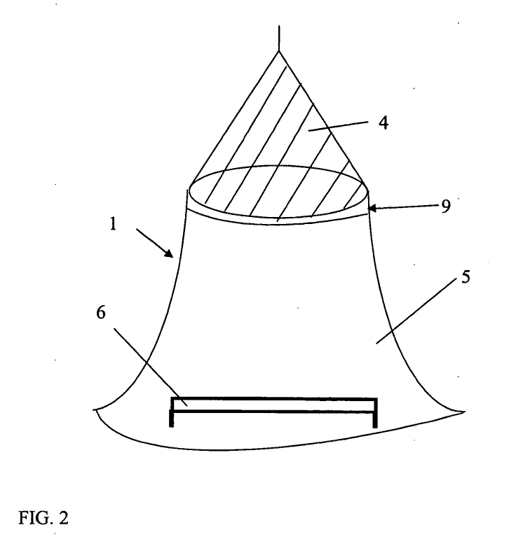

In FIG. 2 illustrates a conical canopy net 1 above a bed 6 to protect human on the bed 6 from being attacked by insects, primarily mosquitoes. The roof 4 of the net 1 comprises a synergist, for example PBO, optionally mixed with an insecticide, and the side walls 5 of the canopy 1 comprise an insecticide. Optionally, the side walls are synergist-free. A stabilising ring 9 is inserted between the roof 4 and the side walls 5.

In one embodiment, the roof 4 may be made of a polymer material, for example polyethylene, being different to the polymer material, for example polyester, of the side walls 5. Using polyethylene for the roof 4 allows incorporation of the synergist into molten polymer at relatively low temperature before extrusion of fibres, because polyethylene has a much lower melting temperature than polyester.

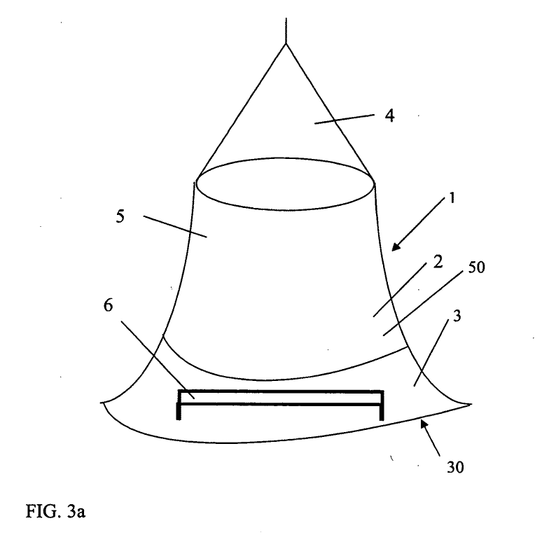

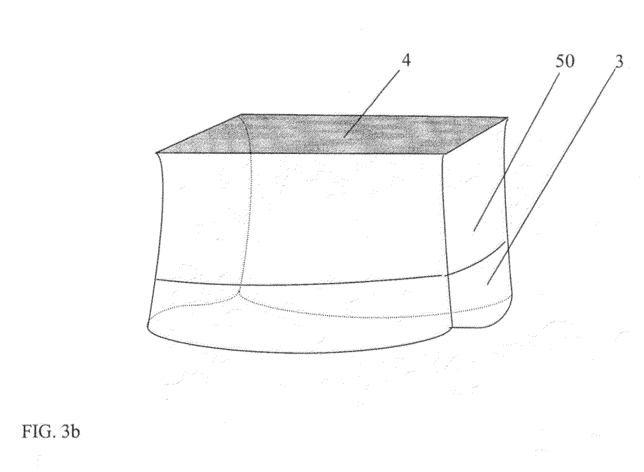

FIG. 3a illustrates a conical canopy insecticidal barrier according to another embodiment of the invention, and FIG. 3b illustrates a rectangular canopy. The barrier 1 has a roof 4 and side walls 5 extending to the lower edge 30 of the barrier, wherein the upper part 2 of the barrier includes the roof 4 and the upper part 50 of the side walls 5, wherein the lower part 3 of the barrier 1 is the lower part of the side walls 5. The canopy insecticidal barrier is intended to cover a space for human beings or animals, for example a bed 6 as illustrated in FIG. 3a. In order to enter the space underneath the canopy, the lower part 3 of the barrier 1 is exposed to surface touch and, therefore, exposed to abrasion of insecticide from the surface of the material. Whereas the upper part 2 is a net typically used for bed nets, the lower part 3 is has a material with higher abrasion resistance and mechanical strength, for example a fabric or a tarpaulin or a combination of these. Also, the lower part 3 may be provided with higher insecticidal content in order to take into account the higher abrasion of the insecticide form the surface of the material.

1. A room for humans or animals, the room comprising a first object and a second object remote from the first object, the first object comprising a first releasable insecticide configured for killing of a mosquito when contacting the first object, the second object comprising a second releasable insecticide configured for killing of the mosquito when contacting the second object, the second insecticide being different from the first insecticide and being configured for insecticidal efficiency against the mosquito despite resistance against the first insecticide.

2. A room according to claim 1, wherein the first object is a fabric

3. A room according to claim 1, wherein the second object is a fabric,

4. A room according to claim 1, wherein the second object is a foil.

5. A room according to claim 1, wherein the second object is a tarpaulin.

6. A room according to claim 1, wherein the first object is a bed net.

7. A room according to claim 6, wherein the bed net has a roof part and side walls, and wherein the roof part comprises a synergist.

8. A room according to claim 7, wherein the synergist is migratably incorporated in the material of the roof part of the bed net.

9. A room according to claim 8, wherein the material of the roof part is polyethylene.

10. A room according to claim 6, wherein the side walls comprise insecticide but no synergist.

11. A room according to claim 9, wherein the material of the side walls is polyester.

12. A room according to claim 10, wherein the first insecticide is impregnated into the side walls of the net.

13. A room according to claim 6, wherein the second object is a wall lining.

14. A room according to claim 13, wherein the wall lining has a top part and a bottom part, and where only the top part contains a releasable insecticide.

15. A room according to claim 14, wherein the top part of the wall lining is provided at a height of more than 1.6 m.

16. A room according to claim 14 or 15, wherein the top part of the wall lining has a dark colour.

17. A room according to claim 13, wherein the wall lining is provided at a height of more than 1 m.

18. A room according to claim 6, wherein the second object is a curtain.

19. A room according to claim 18, wherein the curtain has a top part and a bottom part, and where only the top part contains a releasable insecticide.

20. A room according to claim 19, wherein the top part of the curtain is provided at a height of more than 1.6 m.

21. A room according to claim 1, wherein the first insecticide is migratably incorporated in at least part of the material of the first object

22. A room according to claim 1, wherein the first insecticide is a pyrethroid.

23. A room according to claim 1, wherein the first object comprises a synergist.

24. A room according to claim 23, wherein the synergist is an efficiency enhancer for both insecticides.

25. A room according to claim 24, wherein the synergist is PBO.

26. A room according to claim 23, wherein the synergist is migratably incorporated in at least part of the material of the first object

27. A room according to claim 1, wherein the second insecticide is a pyrethroid-free insecticidal agent.

28. A room according to claim 27, wherein the second insecticide is a Carbamate.

29. A room according to claim 28, wherein the second insecticide is Bendiocarb.

30. A room according to claim 1, wherein the first insecticide is provided on a first part of first object, and the synergist is provided on a second part of the first object but not on the first part.

31. A room according to claim 30, wherein the second part of the first object is above the first part of the first object.

32. A room according to claim 13, wherein the room (11) is part of a but with walls (10) and a roof (15) located above an upper edge (10′) of the wall (10) thereby forming a space (14) between the upper edge (10′) of the wall (10) and an underside (15′) of the roof (15), wherein the space (14) is filled with the wall lining (12).

33. A room according to claim 32, wherein the wall lining (14) extends below the edge (10′) of the wall (10).

34. A method for counteracting resistance of insects against a first insecticide, wherein the method includes
providing a room with a first object and with a second object remote from the first object,
providing the first object with a first releasable insecticide configured for contact killing of a target insect, the first insecticide having a certain probability for inducing resistance against the insecticide among the target insects,
providing the second object with a second releasable insecticide configured for contact killing of the target insect, the second insecticide being different from the first insecticide,
selecting the second insecticide for insecticidal efficiency against the target insect despite resistance against the first insecticide.

35. A method according to claim 34, wherein the first object is a mosquito net and the second object is a wall lining having a bottom part, wherein the method comprises arranging the bottom part at a height of more than 1.0 m.
